(19) United States
(12) Patent Application Publication
(10) Pub. No.: US 2010/0130160 A1
(43) Pub. Date: May 27, 2010

(54) VEHICLE EMERGENCY COMMUNICATION DEVICE AND METHOD FOR UTILIZING THE VEHICLE EMERGENCY COMMUNICATION DEVICE

(75) Inventor: Salem A. Fayyad, Grand Blanc, MI (US)

Correspondence Address: DELPHI TECHNOLOGIES, INC;LEGAL STAFF - M/C 483-400-402, 5725 DELPHI DRIVE, PO BOX 5052, TROY, MI, 48007, US

(73) Assignee: DELPHI TECHNOLOGIES INC., Troy, MI (US)

(21) Appl. No.: 12/276,775

(22) Filed: Nov. 24, 2008

(51) Int. Cl. H04M 11/04

(52) U.S. Cl. 455/404.1

(57) ABSTRACT

A vehicle emergency communication device and a method of utilizing the device are provided. The device includes a portable housing having a first diagnostic link connector, a microprocessor, and an RF transmitter disposed therein. The first diagnostic link connector is configured to be removably connected to a vehicle communication bus, and is further configured to receive a signal indicating deployment of a vehicle airbag from the vehicle communication bus. The microprocessor is configured to induce the RF transmitter to transmit an RF signal having an emergency call message therein in response to receiving the signal from the first diagnostic link connector. The emergency call message has data for inducing a cellular phone receiving the RF signal to further communicate with an emergency call center computer.

### BACKGROUND

A system has been developed that sends a signal to a cellular phone when an air bag has been activated. The system, however, is not portable. Accordingly, the system cannot be easily removed from one vehicle and installed in another vehicle as desired.

Accordingly, the inventors herein have recognized a need for an improved vehicle emergency communication device and method that minimizes and/or eliminates the above-mentioned deficiencies.

### SUMMARY OF THE INVENTION

A vehicle emergency communication device in accordance with an exemplary embodiment is provided. The vehicle emergency communication device includes a portable housing having a first diagnostic link connector, a microprocessor, and an RF transmitter disposed therein. A portion of the first diagnostic link connector extends through the portable housing. The first diagnostic link connector is configured to be removably connected to a vehicle communication bus. The first diagnostic link connector is further configured to receive a signal indicating deployment of a vehicle airbag from the vehicle communication bus. The microprocessor is operably coupled to the first diagnostic link connector and to the RF transmitter. The microprocessor is configured to induce the RF transmitter to transmit an RF signal having an emergency call message therein in response to receiving the signal from the first diagnostic link connector. The emergency call message has data for inducing a cellular phone receiving the RF signal to further communicate with an emergency call center computer.

A method for utilizing a vehicle emergency communication device in accordance with another exemplary embodiment is provided. The method includes disposing a portable housing having a first diagnostic link connector, a microprocessor, and an RF transmitter disposed therein, inside of a vehicle. The method further includes physically coupling the first diagnostic link connector to a second diagnostic link connector coupled to a vehicle communication bus. The method further includes transmitting a signal indicating deployment of a vehicle airbag from a vehicle controller through the vehicle communication bus and the second diagnostic link connector and the first diagnostic link connector to the microprocessor. The method further includes inducing the RF transmitter to transmit an RF signal having an emergency call message therein, utilizing the microprocessor in response to the microprocessor receiving the signal. The emergency call message has data for inducing a cellular phone receiving the RF signal to further communicate with an emergency call center computer.

### BRIEF DESCRIPTION OF THE DRAWINGS

FIG. 1 is a schematic of a vehicle emergency communication device in accordance with an exemplary embodiment; and

FIG. 2 is a flowchart of a method for utilizing the vehicle emergency communication device of FIG. 1 in accordance with another exemplary embodiment.

### DETAILED DESCRIPTION OF EXEMPLARY EMBODIMENTS

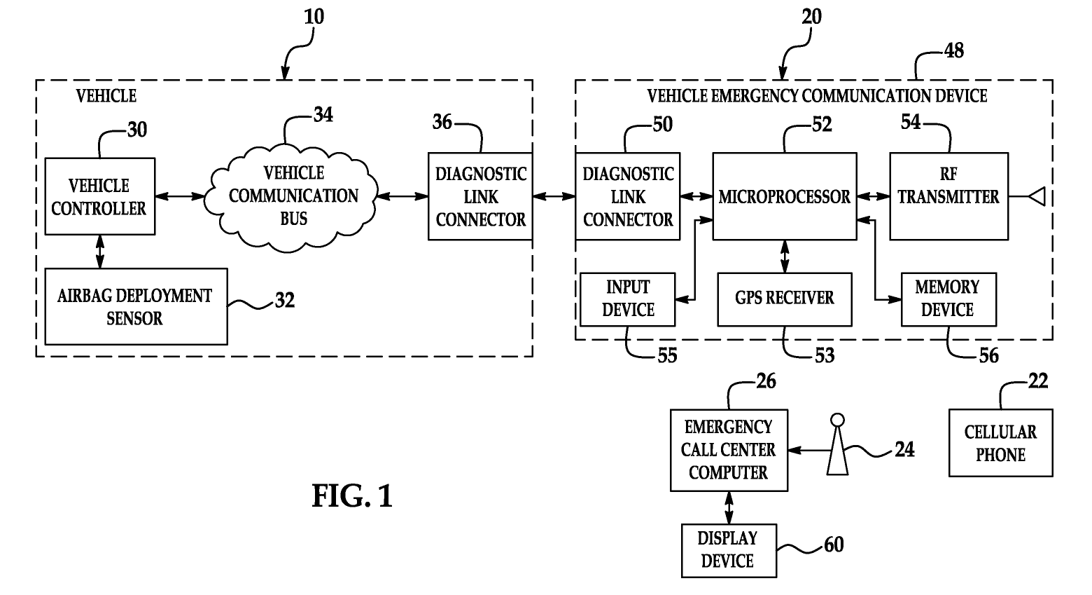

Referring to FIG. 1, a vehicle 10 and a vehicle emergency communication device 20 in accordance with an exemplary embodiment is provided. Further, a cellular phone 22, a cellular tower 24, and an emergency call center computer 26 are illustrated. An advantage of the vehicle emergency communication device 20 is that the device 20 is portable and can be moved between different vehicles if needed. Further, the device 20 can be easily coupled to a vehicle communication bus utilizing a diagnostic link connector.

The vehicle 10 is configured to transport passengers therein. The vehicle 10 includes a vehicle controller 30, an airbag deployment sensor 32, a vehicle communication bus 34, and a diagnostic link connector 36. The airbag deployment sensor 32 is configured to generate a first signal when an airbag module disposed in the vehicle 10 is activated. The vehicle controller 30 receives the first signal from the airbag deployment sensor 32. In response to the first signal, the vehicle controller 30 sends a second signal through the vehicle communication bus 36 to the diagnostic link connector 36, which is received by the vehicle emergency communication device 20.

The vehicle emergency communication device 20 is configured to communicate with both the vehicle controller 30 and the cellular phone 22. The device 20 includes a portable housing 48, a diagnostic link connector 36, a microprocessor 52, a global positioning system (GPS) signal receiver 53, an RF transmitter 54, an input device 55, and a memory device 56.

The portable housing 48 is configured to hold the diagnostic link connector 36, the microprocessor 52, the GPS signal receiver 53, the RF transmitter 54, and the memory device 56 therein. Further, the input device 55 can comprise a keypad that is disposed on an outer surface of the portable housing 48.

The diagnostic link connector 50 extends through an aperture in the portable housing 48 and is configured to be physically and electrically coupled to the diagnostic link connector 36.

The microprocessor 52 is operably coupled to the diagnostic link connector 50, the GPS signal receiver 53, the RF transmitter 54, the input device 55, and the memory device 56. The microprocessor receives GPS position data indicating a position of the vehicle 10 from the GPS receiver 53. The GPS receiver 53 generates the GPS position data based on signals from at least three GPS satellites. Further, the microprocessor 52 receives the first signal from the vehicle controller 30 and induces the RF transmitter 54 to transmit an RF signal having an emergency call message to the cellular phone 22. In one exemplary embodiment, the emergency call message has both (i) the GPS position data indicating a position of the vehicle 10, and (ii) diagnostic codes or data indicating that an airbag has been deployed in the vehicle 10 that is indicative of a vehicle collision. The RF signal can have a Bluetooth communication protocol or other communication protocol known to those skilled in the art. In one exemplary embodiment, the input device 55 is a keypad that allows a user to input data, such as a “make”, a “model” and “year of manufacture” of the vehicle 10 that the microprocessor 52 can utilize to determine a communication protocol and data format utilized by the vehicle 10 for communicating over the vehicle communication bus 34. Further, the microprocessor 52 can utilize the inputted vehicle data to be able to recognize numerical diagnostic codes or data in the emergency call message, utilizing a lookup table with corresponding diagnostic codes or data for example stored in the memory device 56, indicating that airbag deployment in the vehicle 10 has occurred.

The cellular phone 22 is configured to receive the RF signal from the RF transmitter and to send the emergency call message, via another RF signal, to the cellular phone substation 22. The cellular phone substation sends the emergency call message to the emergency call center computer 26. The emergency call center computer 26 displays the emergency call message on the display device 60 so that an operator can contact emergency personnel to dispatch them to the vehicle 10.

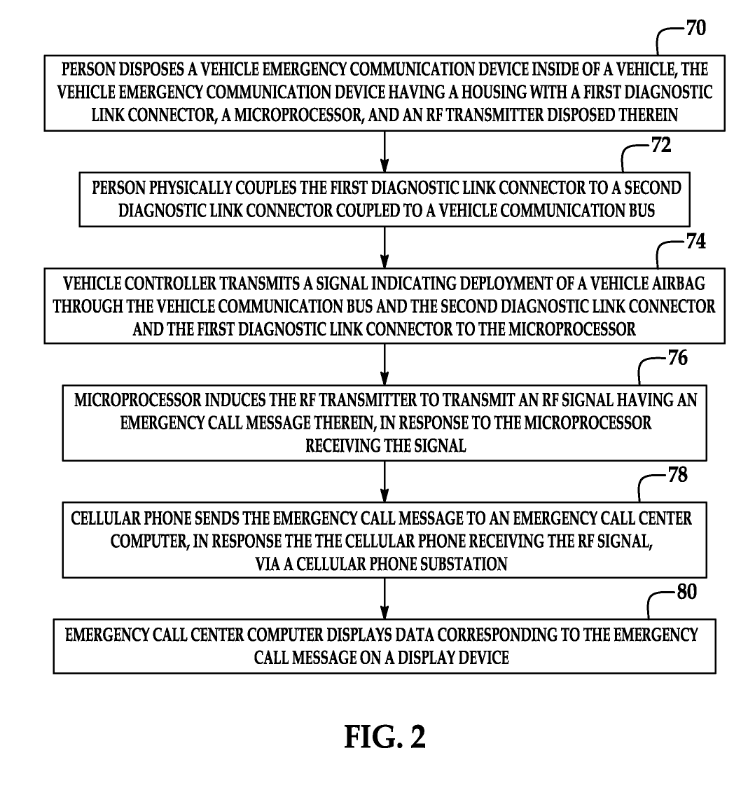

Referring to FIG. 2, a flowchart of a method for utilizing the vehicle emergency communication device 20 in accordance with another exemplary embodiment is illustrated.

At step 70, a person disposes the vehicle emergency communication device 20 inside of the vehicle 10. The vehicle emergency communication device 20 has the housing 48 with the diagnostic link connector 50, the microprocessor 52, and the RF transmitter 54 disposed therein.

At step 72, the person physically couples the diagnostic link connector 50 to the diagnostic link connector 36 coupled to the vehicle communication bus 34.

At step 74, the vehicle controller 30 transmits a signal indicating deployment of a vehicle airbag through the vehicle communication bus 34 and the diagnostic link connector 36 and the diagnostic link connector 50 to the microprocessor 52.

At step 76, the microprocessor 52 induces the RF transmitter 54 to transmit an RF signal having an emergency call message therein, in response to the microprocessor 52 receiving the signal. The emergency call message can include GPS position information from the GPS receiver 53 that indicates a position of the vehicle 10 and a diagnostic code indicating deployment of an airbag module.

At step 78, the cellular phone 22 sends the emergency call message to the emergency call center computer 26, in response to the cellular phone 22 receiving the RF signal, via the cellular phone substation 24.

At step 80, the emergency call center computer 26 displays data corresponding to the emergency call message on the display device 60.

The vehicle emergency communication device and the method for utilizing the device provide a substantial advantage over other devices and methods. In particular, the vehicle emergency communication device and the method provide a technical effect of providing a portable housing that can be easily moved between vehicles and a diagnostic link connector that can be easily coupled to vehicle diagnostic link connectors.

While embodiments of the invention are described with reference to the exemplary embodiments, it will be understood by those skilled in the art that various changes may be made and equivalents may be substituted for elements thereof without departing from the scope of the invention. In addition, many modifications may be made to the teachings of the invention to adapt to a particular situation without departing from the scope thereof Therefore, it is intended that the invention not be limited to the embodiment disclosed for carrying out this invention, but that the invention includes all embodiments falling within the scope of the intended claims. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

What is claimed is:

1. A vehicle emergency communication device, comprising:
a portable housing having a first diagnostic link connector, a microprocessor, and an RF transmitter disposed therein, a portion of the first diagnostic link connector extending through the portable housing;
the first diagnostic link connector is configured to be removably connected to a vehicle communication bus, the first diagnostic link connector is further configured to receive a signal indicating deployment of a vehicle airbag from the vehicle communication bus; and
the microprocessor is operably coupled to the first diagnostic link connector and to the RF transmitter, the microprocessor is configured to induce the RF transmitter to transmit an RF signal having an emergency call message therein in response to receiving the signal from the first diagnostic link connector, the emergency call message having data for inducing a cellular phone receiving the RF signal to further communicate with an emergency call center computer.

2. The vehicle emergency communication device of claim 1, wherein the first diagnostic link connector is configured to be removably physically and electrically coupled to a second diagnostic link connector that is electrically coupled to the vehicle communication bus.

3. The vehicle emergency communication device of claim 1, wherein the RF signal has a Bluetooth communication protocol.

4. A method for utilizing a vehicle emergency communication device, comprising:
disposing a portable housing having a first diagnostic link connector, a microprocessor, and an RF transmitter disposed therein, inside of a vehicle;
physically coupling the first diagnostic link connector to a second diagnostic link connector coupled to a vehicle communication bus;
transmitting a signal indicating deployment of a vehicle airbag from a vehicle controller through the vehicle communication bus and the second diagnostic link connector and the first diagnostic link connector to the microprocessor; and
inducing the RF transmitter to transmit an RF signal having an emergency call message therein, utilizing the microprocessor in response to the microprocessor receiving the signal, the emergency call message having data for inducing a cellular phone receiving the RF signal to further communicate with an emergency call center computer.
